(19) United States
(12) Patent Application Publication
(10) Pub. No.: US 2024/0107635 A1
(43) Pub. Date: Mar. 28, 2024

(54) RADIANT HEATER FOR DEFOGGING LIDAR APERTURE WINDOW

(71) Applicant: Innovusion, Inc., Sunnyvale, CA (US)

(72) Inventors: Chen Gu, San Jose, CA (US); Yimin Li, Cupertino, CA (US)

(73) Assignee: Innovusion, Inc., Sunnyvale, CA (US)

(21) Appl. No.: 18/238,280

(22) Filed: Aug. 25, 2023

Related U.S. Application Data
(60) Provisional application No. 63/409,170, filed on Sep. 22, 2022.

(51) Int. Cl. H05B 6/10; G01S 7/481; G01S 7/497

(52) U.S. Cl. CPC H05B 6/10; G01S 7/4813; G01S 7/497; G01S 2007/4977

(57) ABSTRACT

A radiant heating device for removing and preventing condensation on an aperture window of a light ranging and detection (LiDAR) system is disclosed. The device comprises at least one electromagnetic radiation emitter emitting electromagnetic radiation of one or more frequencies. The electromagnetic radiation radiates at least one aperture surface of the aperture window of the LiDAR system. A portion of the electromagnetic radiation of one or more frequencies is absorbed by the aperture window of the LiDAR system and converted to heat. And the one or more frequencies are different from all frequencies of detection light of the LiDAR system.

### CROSS-REFERENCE TO RELATED APPLICATIONS

This application claims priority to U.S. Provisional Patent Application Ser. No. 63/409,170, filed Sep. 22, 2022, entitled “RADIANT HEATER FOR DEFOGGING LIDAR APERTURE WINDOW,” the content of which is hereby incorporated by reference in its entirety for all purposes.

### FIELD OF THE TECHNOLOGY

This disclosure relates generally to light ranging and detection (LiDAR) system and, more particularly, to methods and devices using direct electromagnetic radiation or radiant energy to remove condensation on an aperture window of the LiDAR system.

### BACKGROUND

Light detection and ranging (LiDAR) systems transmit light beam emissions within a specific range to receive return light. The return light may be formed by objects scattering or reflecting the light beam emissions. The return light is then detected, and the detection signals are processed to generate information about the environment. To maximize the range of detection and to reduce noise in detection, it can be important for the LiDAR systems to have light transmission and reception pathways that are clear and free of obstructions that would block the light from the LiDAR systems or the return light from the environment. A LiDAR system typically has at least one aperture window to allow transmission and reception of light. Therefore, it is important for the aperture window to be free of condensation, dust, or other obstructions.

Aperture windows for automotive LiDAR systems, however, are typically exposed to environmental conditions that may cause water condensation on the external surface of the aperture windows. In particular, condensation forms on aperture windows when warm, moist air comes in contact with a cooler aperture surface. When the air becomes saturated, it no longer holds all the water vapor it contains. The air temperature is at what is known as the dew point temperature. When the temperature of the aperture window surface is lower than the dew point temperature of the surrounding air, water vapor in the air condenses into tiny droplets on the window. As the warm, moisture-laden air reaches the cooler window surface, it cools down, causing the water vapor to lose its energy and transform into liquid form, resulting in condensation.

An aperture window of a LiDAR system is typically mounted to, or integrated with, a LiDAR housing. Humidity levels and temperature differences between the external environment and the materials of the LiDAR housing can contribute to the formation of condensation on aperture windows. High humidity levels during a foggy or rainy day or a hot humid day may increase the likelihood of condensation. Additionally, inadequate insulation and poor ventilation can create temperature disparities between the interior and exterior of an aperture window or the housing of a LiDAR system, making it more prone to condensation. Disadvantageously, condensation can block or scatter light emitted from the LiDAR system or return light formed from object reflection or scattering in the environment.

Vehicle defogging mechanisms may include using heating wires attached to or embedded in a rear panel window. Using similar heating wires on a LiDAR aperture window, however, may be impractical or inefficient. This is because the attachment of heating wires to an aperture window can block light exiting or entering the LiDAR system. In addition, to minimize the blockage of the aperture window, heating wires can only be attached to a small portion of the window. As a result, the heat generated by the heating wires can only be spread to other portions of the window by thermal conduction via the window. The material of an aperture window is typically not a good thermal conductor, and therefore it may take a long time for the heat to be conducted to the entire window. The delay caused by thermal conduction may impact the LiDAR's performance because the data generated by the LiDAR system during the thermal conduction time may not be used. In turn, this may cause significant issues with a vehicle operation, particularly if the vehicle is moving at a high-speed or in a crowded environment.

There are also other ways to limit condensation, including the use of an approximately transparent electrically resistive film attached or deposited on the aperture window to electrically heat the aperture window. However, the electrically resistive film also may block some portions of the light exiting or entering the LiDAR system. Further, the electrically resistive film may not be able to heat the aperture window fast enough, and it may also be damaged if it is heated too quickly.

### SUMMARY

The present disclosure includes a novel radiant heating device using direct electromagnetic radiation or radiant energy to remove condensation on an aperture window of a LiDAR system.

In one embodiment, an exemplary radiant heating device is disclosed. The radiant heating device includes at least one electromagnetic radiation emitter emitting electromagnetic radiation of one or more frequencies. The electromagnetic radiation can radiate at least one aperture surface of the aperture window of the LiDAR system. A portion of the electromagnetic radiation of one or more frequencies is absorbed by the aperture window of the LiDAR system and converted to heat. The one or more frequencies are different from all frequencies of detection light of the LiDAR system.

In another embodiment, a Light Ranging and Detection (LiDAR) system is disclosed. The LiDAR system includes a housing; one or more supporting arms coupled to the housing of the LiDAR system proximate to an aperture window; at least one electromagnetic radiation emitter coupled to the one or more arms or a portion of the housing; and a controller configured to control the at least one electromagnetic radiation emitter to emit electromagnetic radiation of one or more frequencies. The electromagnetic radiation radiates at least one aperture surface of the aperture window of the LiDAR system. A portion of the electromagnetic radiation of one or more frequencies is absorbed by the aperture window of the LiDAR system and converted to heat. The one or more frequencies are different from all frequencies of detection light of the LiDAR system.

The present disclosure provides several advantages. The radiant heating device can remove condensation from the aperture window of the LiDAR system in an efficient and timely manner. Using the radiant heating device, the thermal conduction is more rapid compared to other ways of heating, such as using the heating wires. Thus, the operation of the radiant heating device causes no delay (or minimum delay) or interrupt with the normal operation of the LiDAR system, which may be providing critical data to a vehicle control system for maneuvering the vehicle. In addition, the radiant heating devices provided in this disclosure can be placed outside of the pathways of both the transmission light and return light, thereby eliminating any blockage of the exiting light and return light compared to using heating wires or resistive films. As a result, return signals are not blocked, falsely detected, or distorted due to condensation.

Moreover, the wavelengths of the emission used for heating the aperture window of the LiDAR system can be selected to avoid the operational wavelength range of the LiDAR system. Accordingly, the technology disclosed herein improves the signal quality and signal-to-noise ratio of the LiDAR system. In turn, the improvement of the signal quality improves the data accuracy of the LiDAR system and therefore providing an enhanced point cloud for downstream processing such as object recognition, obstacle prediction, vehicle planning, and vehicle movement controlling. Furthermore, the LiDAR system having a radiant heating device as disclosed herein can maintain a low cost by using materials that are most efficient for the purpose of removing condensation and with low cost. Overall, the LiDAR system having the radiant heating device improves the performance of return light detection.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed of or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7A is a block diagram illustrating a LiDAR system with example radiant heating devices disposed proximate to an aperture window of the LiDAR system, according to some embodiments.

FIG. 7B is a perspective view illustrating example radiant heating devices mounted to a simplified LiDAR system for removing and preventing condensation on an aperture window of the LiDAR system, according to some embodiments.

FIG. 7C is a diagram illustrating radiating heat emissions toward an aperture window by selected radiant heating devices, according to some embodiments.

FIG. 7D is a diagram illustrating another embodiment of mounting the radiant heating devices to a LiDAR system to enable conductive heating, according to some embodiments.

FIG. 8 is a table illustrating the various performance characteristics of some exemplary types of heaters that may be used in the radiant heating devices.

FIG. 9 illustrates an exemplary emission spectrum of different types of emission elements.

FIG. 10 illustrates exemplary emission spectrum of an exemplary white light emitting device (LED).

FIG. 11 illustrates exemplary wavelength transmissivity characteristics of a 10 millimeter thick sample of exemplary uncoated N-BK7 glass used for optical applications such as the material for the aperture window.

FIG. 12 illustrates exemplary wavelength transmissivity characteristics of a 3 millimeter thick sample of exemplary RG-1000 material used for optical applications such as the material for the aperture window.

FIG. 13 illustrates exemplary wavelength absorption characteristics of water.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first electromagnetic radiation emitter could be termed a second electromagnetic radiation emitter and, similarly, a second electromagnetic radiation emitter could be termed a first electromagnetic radiation emitter, without departing from the scope of the various described examples. The first electromagnetic radiation emitter and the second electromagnetic radiation emitter can both be part of one electromagnetic radiation emitter and, in some cases, can be separate and different electromagnetic radiation emitter.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

One frequent application of a LiDAR system is to place it internal and/or external to a vehicle to detect objects within a specific range of the vehicle. Yet, in order to maximize the range of detection and reduce noise, LiDAR systems should possess light transmission and reception pathways that are clear and free of obstructions that would block the light from the LiDAR systems or scattered return light from the environment. This means that at least one aperture window of the LiDAR system should allow transmission and reception of light, keeping the aperture window free of condensation, dust, or other obstructions. The LiDAR system disclosed herein comprises defogging or condensation removing mechanisms such as a device using direct electromagnetic radiation or radiant energy to remove condensation on an aperture window of a LiDAR system. In this disclosure, the term defogging and removing condensation are used interchangeably, both referring to removing moisture, water, or any other liquid, however small it is, from an aperture window of the LiDAR system. Specifically, the radiant heating device disclosed herein may include at least one electromagnetic radiation emitter emitting electromagnetic radiation of one or more frequencies. The electromagnetic radiation can be directed toward at least one aperture surface of the aperture window of the LiDAR system. A portion of the electromagnetic radiation of one or more frequencies may be absorbed by the aperture window of the LiDAR system and converted to heat. The benefits of the present disclosure include but are not limited to: (1) enhanced detection performance of the LiDAR system; (2) maximized range of detection; (3) reduction of noise and distorted detection signals; (4) greater system efficiency; and (5) cost effective condensation removal.

Embodiments of present invention are described below. In various embodiments of the present invention, a radiant heating device may include at least one electromagnetic radiation emitter emitting electromagnetic radiation of one or more frequencies. The electromagnetic radiation can radiate at least one aperture surface of the aperture window of the LiDAR system. A portion of the electromagnetic radiation of one or more frequencies may be absorbed by the aperture window of the LiDAR system and converted to heat. In some embodiments, the at least one electromagnetic radiation emitter is positioned external or internal to the LiDAR system. In one example, the emitted electromagnetic radiation radiates toward an aperture surface that is exterior of the LiDAR system. In another example, the emitted electromagnetic radiation radiates toward an aperture surface that is interior of the LiDAR system.

In another example, a LiDAR system includes a housing, one or more supporting arms coupled to the housing of the LiDAR system proximate to an aperture window; at least one electromagnetic radiation emitter assembly coupled to the one or more arms or a portion of the housing; and a controller configured to control the at least one electromagnetic radiation emitter to emit electromagnetic radiation of one or more frequencies. The electromagnetic radiation radiates at least one aperture surface of the aperture window of the LiDAR system. A portion of the electromagnetic radiation of one or more frequencies is absorbed by the aperture window of the LiDAR system and converted to heat. The one or more frequencies are different from all frequencies of detection light of the LiDAR system.

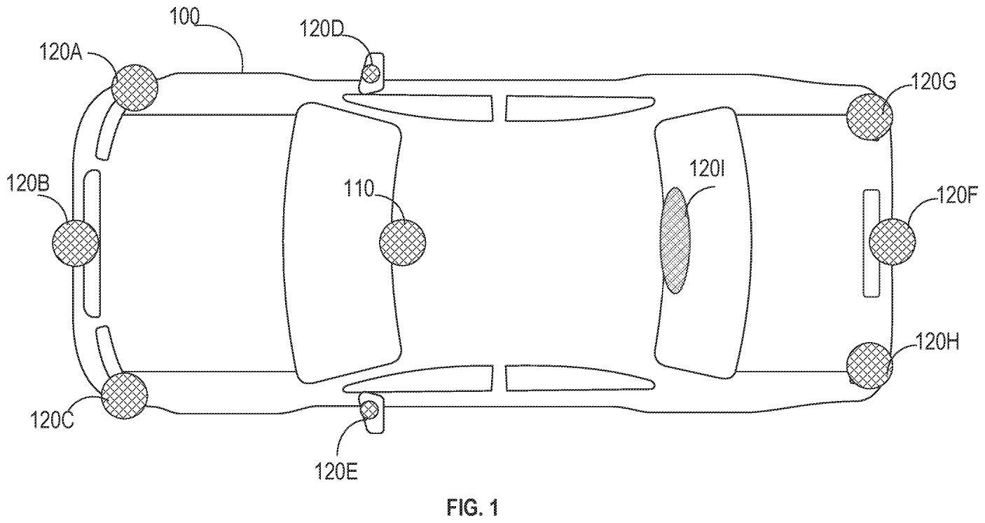

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

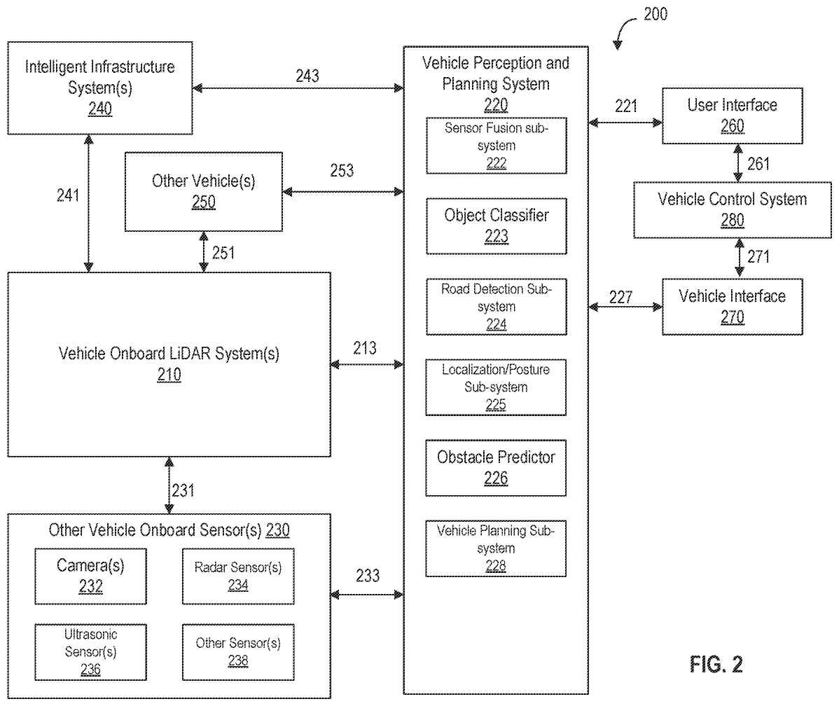

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

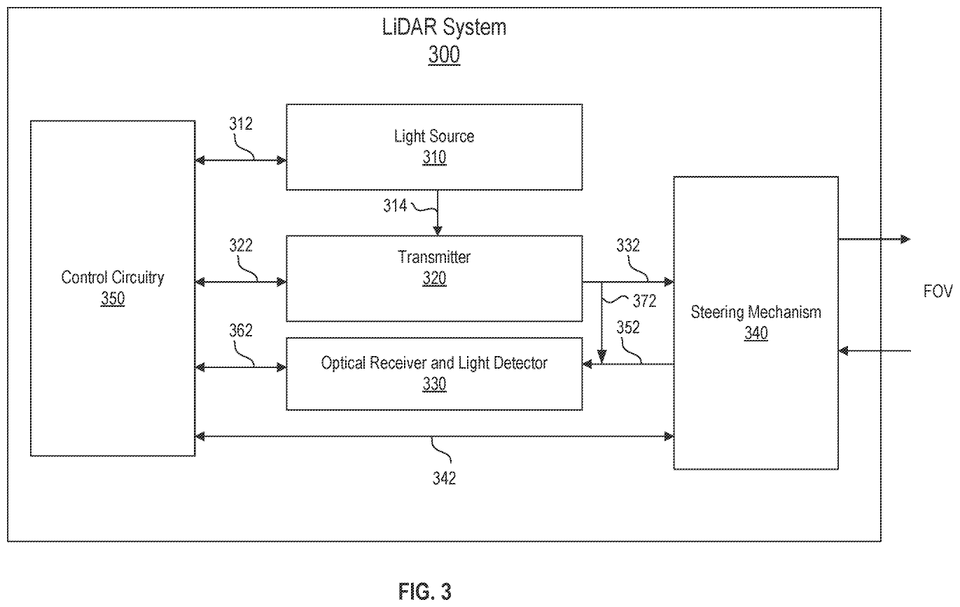

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

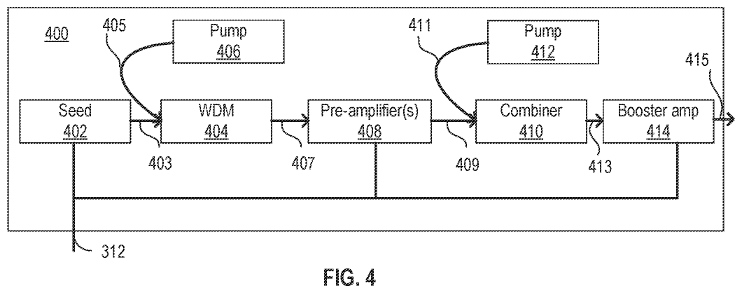

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering with the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

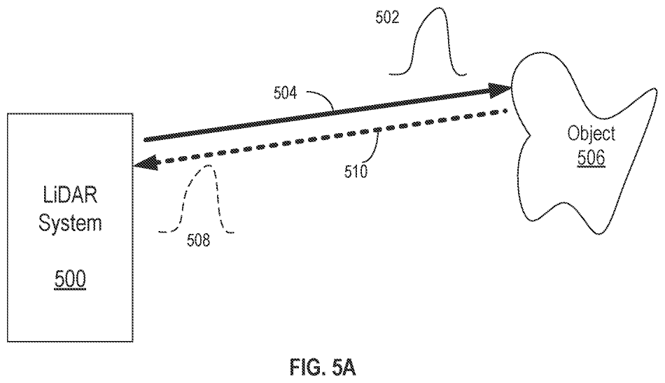

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

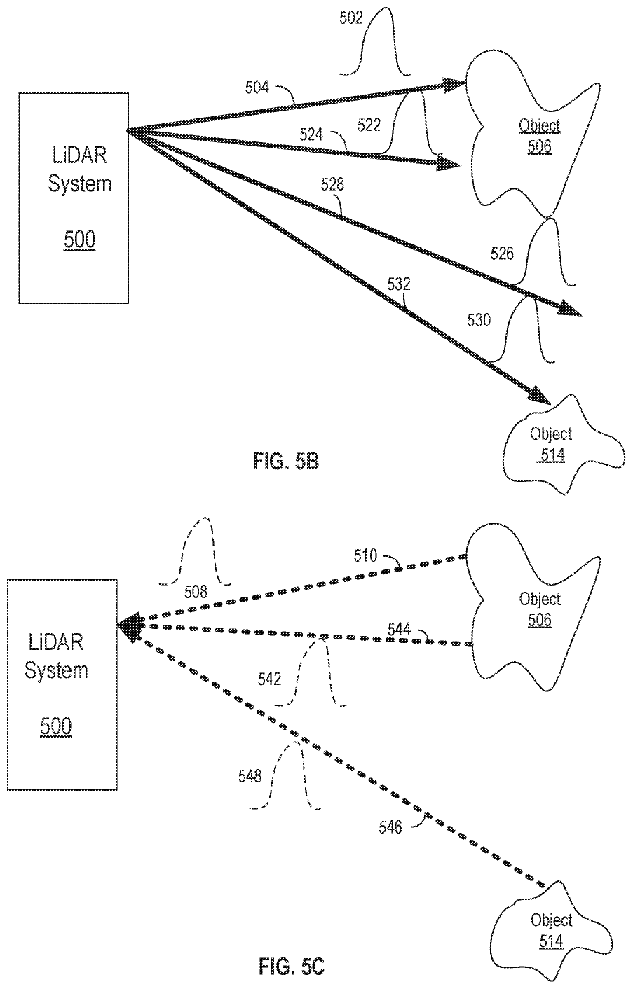

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-13. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

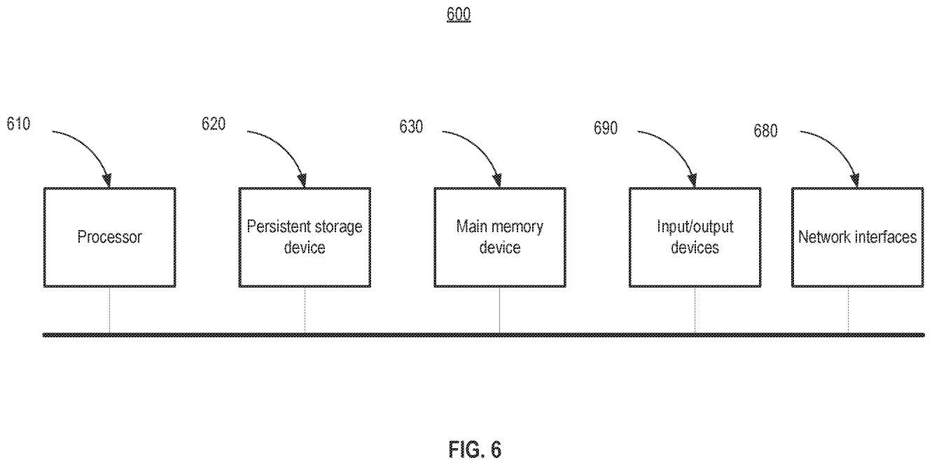

FIG. 7A is a block diagram illustrating a LiDAR system 700 with an example radiant heating device 710 disposed proximate to an aperture window 720 of the LiDAR system 700, according to some embodiments. Radiant heating device 710 includes one or more electromagnetic radiation emitters 730A-730D (collectively as emitters 730). FIG. 7B is a perspective view illustrating an example radiant heating device 710 mounted to a simplified LiDAR system 700 for removing and preventing condensation on an aperture window 720 of the LiDAR system 700, according to some embodiments. FIG. 7C is a diagram illustrating radiating emissions toward an aperture window 720 by selected emitters 730 of radiant heating device 710, according to some embodiments. FIG. 7D is a diagram illustrating another embodiment of mounting the radiant heating device 710 to a LiDAR system to enable conductive heating, according to some embodiments.

LiDAR system 700 shown in FIG. 7A is a simplified view, but can include components or subsystems that are the same or substantially similar to those of LiDAR system 300 described above. FIG. 7A illustrates an example radiant heating device 710 that includes a plurality of radiant emitters. Four emitters 730A-730D, also referred to collectively as 730, are shown in FIG. 7A for illustration. Two emitters 730A and 730B are disposed exterior of LiDAR system 700 and two are disposed interior of LiDAR system 700. In one embodiment, LiDAR system 700 has a housing 790. Housing 790 encloses components of LiDAR system 700. An aperture window 720 is mounted to, or integrated with, housing 790 mechanically. In one example, aperture window 720 forms a part of housing 790. It is understood that radiant heating device 710 may include any number of emitters 730, which can be disposed and distributed in any desired manner (interior or exterior of housing 790, or integrated with housing 790), not limited to the manner shown in FIG. 7A.

With reference to FIG. 7A, system 700 includes, among other things, steering mechanism 740 for scanning transmission light 762 to a field-of-view (FOV) via the aperture window 720. Steering mechanism 740 can be the same or substantially the same as steering mechanism 340 shown in FIG. 3. For example, steering mechanism 740 may include a rotatable polygon mirror, an oscillating mirror, a MEMS mirror, any other mechanisms, or a combination thereof to scan the light to the FOV. The scanning of the light can be in two directions. For instance, a rotatable polygon mirror may be configured to scan the horizontal direction; and an oscillating mirror may be configured to scan the vertical direction. The light scanned to the FOV can include one or more light beams, thereby forming one or more transmission channels. Steering mechanism 740 may also be configured to receive return light 760 formed by objects reflecting or scattering the transmission light. These objects are located within the FOV. The return light 760 is received by the steering mechanism 740 via the aperture window 720. In one example, the steering mechanism 740 provides a co-axial optical system because the transmission and receiving of light are both enabled by the same optics (e.g., the same rotatable polygon mirror and oscillating mirror).

If the aperture window 720 has no condensation, and is otherwise free of obstructions, transmission light 762 and return light 760 can pass through the aperture window 720 without interference. In some situations, as described above, liquid condensation 725 may form on the external surface of aperture window 720. Depending on the degree of the condensation, some of transmission light 762 may be reflected back to the inside of LiDAR system 700, forming noise if they were eventually detected by the detector. As shown in FIG. 7A, some of the return light 760 may also be blocked from passing through aperture window 720, and are scattered away from LiDAR system 700, resulting in a signal loss.

With continued reference to FIG. 7A, to efficiently solve the condensation problem without affecting the normal operation of the LiDAR system, a radiant heating device 710 having one or more electromagnetic radiation emitters 730 can be disposed proximate to the aperture window 720. In the example shown in FIG. 7A, two emitters 730 are disposed exterior of LiDAR system 700 and two are disposed interior of LiDAR system 700. In one embodiment, the emitters 730, whether disposed exterior or interior of housing 790, can be positioned outside of light paths of the transmission light 762 and return light 760. As a result, the emitters 730 themselves do not block or otherwise interfere with the light paths.

As shown in FIG. 7A, the emitters 730 can each be controlled via a controller 750. Controller 750 can be, for example, a part of control circuitry 350 described above. Controller 750 can be configured to communicate (wired or wirelessly) with each of the emitters 730 of radiant heating devices 710 to send control signals and receive feedback signals. For example, controller 750 can send one or more control signals to emitters 730 to: turn on some of the emitters (e.g., 730A and 730B), turn off some of the emitters (e.g., 730C and 730D), increase or reduce the voltage and/or current supplied to any of the radiation emitters 730, reposition the emission direction (e.g., by slighting rotating a reflector of an emitter 730), or perform any other functions (e.g., change the wavelength of the emitter, set a timer for an emitter for a delayed turning off, set a date/time schedule to turn on an emitter, etc.). The electromagnetic radiation emitted from one or more emitters 730 can be directed to aperture window 720 to evaporate condensation 725, so that the transmission light 762 and return light 760 can pass through window 720 clear of obstructions.

In some embodiments, as illustrated in FIG. 7A, radiant heating device 710 may be configured to operate with a condensation monitor comprising one or more sensors 770. In one embodiment, sensors 770 may be mounted to housing 790 and may be disposed proximate to aperture window 720. In one example, the sensors 770 can emit light to detect if the transmission light directed by steering mechanism 740 (or another light source) is reflected back by the aperture window 720 to the interior of LiDAR system 700. If the light is reflected back, there may be condensation formed on aperture window 720. If more light is reflected back to the interior of the LiDAR system 700, it may indicate that more condensation has been formed. In another example, the sensors 770 may be capacitive sensors with electrodes attached to the aperture window 720. The sensors 770 may send current pulses to the electrodes and measure the capacitance of the electrodes based on measured voltage changes on the electrodes. Because the presence of water condensations and/or rain drops on the aperture window 720 can alter the capacitance characteristics of the electrodes on the aperture window, the sensors 770 can detect presence of water condensations and/or rain drops effectively using capacitive measurements. In one embodiment, sensors 770 are integrated with LiDAR system 700. In another embodiment, the LiDAR system 700 itself can be configured to detect condensation by monitoring and detecting blockage of transmission light by the aperture window having condensation. For example, if the detector(s) of LiDAR system 700 detect many scattered or reflected return light at the distance corresponding to the aperture window, it may determine that there is condensation or blockage at the aperture window. In these embodiments, sensors 770 may not be required.

In some embodiments, sensors 770 and/or detector(s) of LiDAR system 700 monitors the condensation of aperture window 720 and communicates with controller 750 to deliver the condensation monitoring results. The communication may be performed using electrical wire or wirelessly. The monitoring results may include information of light reflection, which is used by controller 750 to analyze whether there is condensation formed on aperture window 720, the degree of condensation (e.g., based on the amount of light obstructed by the condensation), positions of the condensation on aperture window 720, and/or other information related to aperture window blockage due to condensation. For instance, sensors 770 and/or detectors of LiDAR system 700 may detect a scattered reflection of transmission light by aperture window 720, a partial blockage of light and a partial transmission of light in the same area, or a blockage of light in certain area of window 720 and a blockage of light other area of window 720.

Based on the analysis results, the controller 750 can be configured to control one or more emitters 730. For instance, based on the analysis results, controller 750 may send signals to activate one or more emitters 730. Briefly referring to FIG. 7C, for instance, the controller 750 may determine that there is condensation formed on aperture window 720, and the condensation is of a moderate degree. As such, it activates the two externally-positioned emitters 730A and 730B, while keeping the two internally-positioned emitters 730C and 730D off or deactivated. In another example, if the condensation mainly formed at the upper portion of the aperture window 720, the controller 750 may turn on or activate the two emitters 730A and 730D located near the upper portion of the aperture window 720, while keeping the other two emitters 730B and 730C off or deactivated. It is understood that controller 750 can selectively turn on or activate any one or more of the multiple emitters 730 to emit radiation for evaporating condensation. The selectively activation capability can facilitate saving energy and thus improving power efficiency. In some embodiments, controller 750 can factor in other information to determine whether to activate emitters 730. For instance, controller 750 may be provided with vehicle status data (e.g., whether the vehicle is operating or turned off, speed of the vehicle, etc.) and/or environmental data from other sensors (e.g., whether the wiper blade is activated, which indicates whether the blockage of the LiDAR system's aperture window 720 is due to rain). Based on the additional information, controller 750 may, for example, instruct more or fewer emitters to turn on (e.g., due to continuous condensation from the rain or minor condensation), instruct the emitters to raise or lower the temperature to provide more or less emission radiation, etc.

In some embodiments, sensors 770 may include (separately or additionally) temperature sensors for sensing the temperature of aperture window 720. The temperature sensors may be distributed at different locations of aperture window 720, or may be contactless temperature sensors. The temperature sensors sense the temperature of the aperture window 720 and communicate the temperature data to controller 750. In one example, during nighttime, if controller 750 detects that the temperature of aperture window 720 drops below a certain threshold temperature, it can instruct one or more emitters 730 to activate to heat up the aperture window 720. Thus, by keeping the aperture window 720 warm, condensation may not be formed in the first place. In other embodiments, controller 750 can assume that when temperature drops below a certain threshold, condensation will form. Thus, it can activate one or more emitters 730A to heap up the aperture window 720 to remove condensation.

With reference back to FIG. 7B, a perspective view of an exemplary radiant heating device 710 is shown. As described above, device 710 is configured to remove and prevent condensation on an aperture window 720 of a LiDAR system 700. The device 710 may include one or more electromagnetic radiation emitters 730. Four such emitters 730A-730D are shown in FIG. 7B. The emitters emit electromagnetic radiation of one or more frequencies. As shown in FIG. 7B, emitters 730A-730D are coupled mechanically to supporting arms 752A-752D, respectively. Supporting arms 752A-752D mechanically couple the emitters 730A-730D to the LiDAR system 700 at, for example, housing 790 and/or aperture window 720. In some embodiments, supporting arms can include ridge plates fixedly or moveably coupled to the housing 790 of LiDAR system 700 and/or emitters 730A-730D. As described above, emitter 730A-730D can be distributed in a manner to maximize the radiation toward aperture window 720 while avoiding blocking or interfering with the light path of the LiDAR system 700. In some embodiments, the supporting arms 752A-752D are coupled to emitters 730A-730D via mechanisms (shafts, hinges, etc.) that enable the emitters 730A-730D to move within a certain degree. The movements of the emitters adjust or reposition the emitters, thereby redirecting the radiation to aperture window 720 achieve better heating efficiency.

As shown in FIG. 7B, housing 790 of the LiDAR system 700 may include a top panel, a bottom panel, and at least three side panels coupled between the top panel and the bottom panel to form a container for housing components of the LiDAR system 700 (not shown in FIG. 7B). In the embodiment shown in FIG. 7B, aperture window 720 is fixedly coupled (e.g., using adhesives, slots, fasteners, etc.) to two side panels, the top panel, and the bottom panel. The aperture window 720 comprises aperture surfaces 721 and 722. One or more radiation emitters 730A-730D couple to at least one of the housing 790's top panel, bottom panel, side panels, and/or the aperture window 720. Specifically, the coupling can use supporting arms 752A-752D (collectively 752) disposed adjacent to the aperture window 720. In one embodiment, emitters 730A-730D also include reflectors 741-744 coupled between supporting arms 752 and chassis 754. Chassis 754 form supporting structures for electromagnetic radiation emission elements 731-734. As described below, the one or more electromagnetic radiation emission elements 731-734 receive electrical voltages or currents from a power supply (e.g., in the control circuitry) via chassis 754 to emit electromagnetic radiation of one or more frequencies differing from light frequencies ordinarily detected by the LiDAR system 700. In particular, a portion of the electromagnetic radiation is aligned to be absorbed by the at least one aperture surface 721 and/or 722 and condensation water seated on the at least one aperture surface evaporates.

In some embodiments, radiation emitters 730A-730D include emission elements 731, 732, 733, and 734, respectively, for emitting electromagnetic radiations. In one example as shown in FIG. 7B, the emission element has a bar shape. The emission elements 731, 732, 733, and 734 may be oriented such that their longitudinal directions are parallel to the aperture surface of window 720. This orientation may help improve the radiation efficiency because the radiation can be better directed toward the aperture surface of window 720.

As shown in FIG. 7B, the electromagnetic radiation radiates emissions toward one or more surfaces 721 and 722 of the aperture window 720 of the LiDAR system 700. Aperture surface 721 is the exterior surface of window 720 facing the external environment of LiDAR system 700; and aperture surface 722 is the interior surface of window 720 facing the internal components of LiDAR system 700. In one example, emitters 730A and 730B can be used to emit radiations to heat up exterior surface 721 to evaporate the condensation on surface 721; and emitters 730C and 730D can be used to emit radiations to heat up interior surface 722 to evaporate the condensation on surface 722. It is understood that because window 720 can conduct heat, therefore, radiation emitted toward one of surfaces 721 or 722 can also facilitate heating up the other surface. A portion of the electromagnetic radiation of one or more frequencies may be absorbed by the aperture window 720 of the LiDAR system 700, which causes the aperture window 720 to heat up, such that the condensation evaporates off of the aperture window 720. A portion of the electromagnetic radiation of the one or more frequencies may also be absorbed by the condensation water on either surface 721 or 722 of the aperture window 720, also causing the condensation to evaporate off of the aperture window 720.

Furthermore, as described above, one or more electromagnetic radiation emitters 730A-730D may be positioned external or internal to the LiDAR system 700, e.g., positioned exterior of the LiDAR system 700's housing 790, or positioned interior of the LiDAR system 700's housing 790. Positioning electromagnetic radiation emitters interior of housing 790 shield the electromagnetic radiation emitters from dust and contaminations from the outside. Further, if the emitters are placed only interior of the housing 790, the impact to aerodynamic aspects of the LiDAR system (particularly when it is mounted to a vehicle) may be minimized. Placing at least some of the emitters exterior of housing 790 can radiate emissions directly onto the exterior surface 721 of aperture window 720, thereby increasing the evaporation speed of the condensation and in turn improve the overall condensation removing performance.

With reference to FIG. 7C, electromagnetic radiation emitters 730A and 730B may both be activated to radiate toward an aperture surface 721. The areas of radiation from emitters 730A and 730B may or may not overlap. If the areas of radiation from multiple emitters overlap, the condensation at the overlapped area may evaporate faster than other areas. Controller 750 (shown in FIG. 7A) can be used to control overlapping or non-overlapping the areas of radiation from multiple emitters. Because condensation may form on the aperture surface 721 that is exterior of the LiDAR system 700, the electromagnetic radiations from the emitters 730A and 730B may more effectively heat up the aperture surface 721, conduct the heat to the condensation on the aperture surface 721, and evaporate the condensation on the aperture surface 721. Similarly, radiation from emitters 730C and 730D (if they are turned on), may or may not overlap on aperture surface 722. The heat can be conducted by radiation to window 720 and in turn to condensation on aperture surface 721. Eventually, the condensation on aperture surface 721 can be evaporated. Using the emitters 730C and 730D to evaporate the condensation on the exterior surface 721 may not be as effective as using emitters 730A and 730B, but may still be acceptable in certain situations.

In one example, with reference to FIGS. 7B and 7C, emitters 730A-730D may include reflectors 741, 742, 743, and 744 respectively. Reflectors 741, 742, 743, and 744 can be mechanically coupled to supporting arms 752A-752D respectively and coupled to emission elements 731, 732, 733, and 734, respectively via chassis 754. Chassis 754 may be rigid or flexible grips (e.g., pipes, bars, ropes, hinges, fasteners, etc.) configured to connect an emission element and a corresponding reflector. Chassis 754 also provides support to the emission elements 731-734 to hold them in place. In some embodiments, chassis 754 can also provide electrical connections (e.g., using electrical wires) to supply voltage and/or current to the emission elements 731-734.

In some embodiments, reflectors 741, 742, 743, and 744 are configured to be curved. These reflectors have reflective inner surfaces configured to reflect the electromagnetic radiation onto the aperture surfaces of aperture window 720. The curvature of the reflectors can be designed to have a certain degree such that the focal point of the radiation is positioned on or proximate to the aperture surface (either surface 721 or 722) of window 720. In some examples, the one or more reflectors 741-744 may each be shaped to allow the one or more electromagnetic radiation emitters 730A-730D to evenly distribute electromagnetic radiation over the aperture surfaces 721 and/or 722 to allow even heating and evaporation of condensation. For example, the curvature of the reflectors 741-744 may also be designed such that the radiation from each emitter is projected evenly onto the aperture surface 721 or 722, without concentrating on any single point or a small area.

With reference to FIG. 7D, in some embodiments, at least a portion of one or more emitters 730A-730D may directly contact with the aperture window 720. For example, one or more reflectors 741-744 may be positioned such that they directly contact the aperture window 720 to transfer heat by conduction to the aperture window 720. The direct contact heating may provide additional heat to heat the aperture window 720 to evaporate condensation on the aperture window 720. The reflector may be made of metal or alloy materials such that the thermal conduction through contacting with the aperture window can be more effective. The direct-contact thermal conduction can further enhance the speed of heat transfer from the emitters 730A-730D to aperture window 720.

It is understood that FIGS. 7A-7D merely illustrates several examples of positions and orientations of emitters 730A-730D. Other positions and orientations of the one or more electromagnetic radiation emitters 730A-730D may also be possible, such as on various sides or corners of the aperture window 720, internal or external of the housing 790 of the LiDAR system 700. While FIGS. 7A-7D illustrate that the exemplary aperture window 720 is flat with planar surfaces, the present disclosure does not exclude other shapes and forms of aperture windows, which may include cylindrical, spherical, aspherical, concave polygon, convex polygon, free-form, meniscus, in shape, in whole or in part. The one or more electromagnetic radiation emitters 730A-730D and the corresponding one or more reflectors 741-744 may be shaped and positioned to evenly distribute electromagnetic radiation over the aperture surfaces 721 and/or 722 to allow even or concentrated heating and evaporation of condensation.

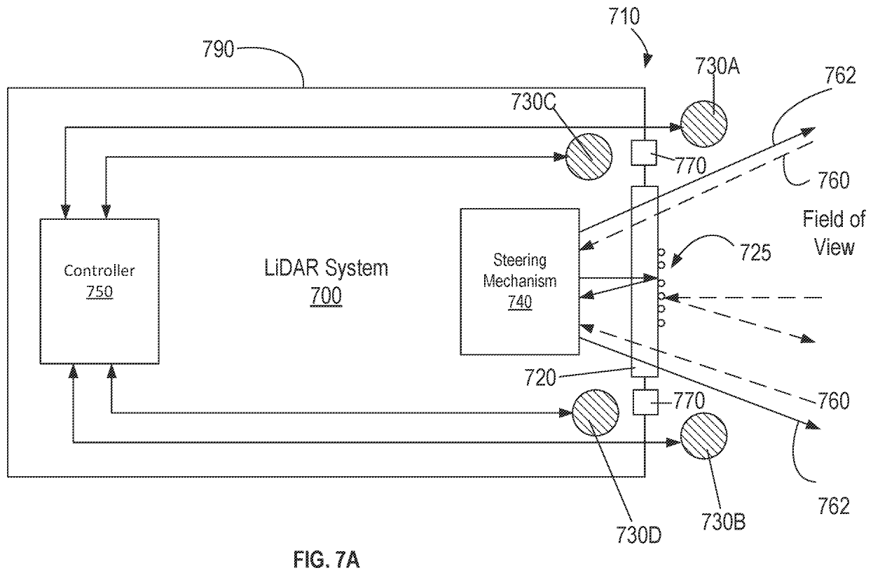

FIG. 8 is a table illustrating the various performance characteristics of some exemplary types of emission elements that may be used in the emitters 730 of radiant heating device 710 described above. These emission elements can operate to emit infrared emissions to heat up objects, and thus can be used to implement electromagnetic radiation emitters (e.g., emitters 730A-730D). As shown in the table of FIG. 8, when selecting a type of emission element, there are typically five characteristics in consideration. The five characteristics include radiant efficiency, physical strength, time to heat up or cool down, operational temperature, and color sensitivity. The radiant efficiency is defined as the ratio of the energy radiated in the form electromagnetic radiation (e.g., infrared light) to the total energy supplied to the emission element of the electromagnetic radiation emitter. The physical strength refers to the emission element's capability of resistance to physical impact such as vibration. The time to heat up and cool down refers to how fast or slow the emission element can reach certain specified temperature to emit radiation; and how fast or slow the emission element can cool down to a normal temperature (e.g., the room temperature or a temperature that has no or minimum emission). The temperature in the table of FIG. 8 refers to the specified operational temperature of the emission element. The color sensitivity relates to the bandwidth of the radiation emitted from the emission element. Certain types of emission elements have a low color sensitivity so that radiation with different wavelengths or a wide range of wavelengths can be absorbed by the aperture window. Other types of emission elements have a high color sensitivity such that the radiation only has a narrow band of wavelengths. High color sensitivity emission elements may require using a corresponding material such that the aperture window can better absorb the radiation for removing the condensation.

The table shown in FIG. 8 listed several types of emission elements, including metal sheath based elements, quartz tube based elements, quartz lamp based elements, catalytic-based emission elements, flat faced panel based elements, and ceramic based elements. As can be seen from FIG. 8, out of the six types of emission elements listed, the ceramic based emission elements provide the greatest radiant efficiency of 96%. Metal sheath based and catalytic based emission elements possess the most physical strength. Quartz lamps based emission elements have very fast heating and cooling speeds (e.g., reaching the operating temperature in a few milliseconds) such that they may be used to flash heating or rapid heating. Fast heating capability may be desired for evaporating condensations on aperture windows of LiDAR systems so that the delay or interruption to the LiDAR system's normal operation can be minimized. However, quartz lamps, by themselves without physical enhancement, may be susceptible to physical impact. Quartz lamps based emission elements thus may be susceptible to severe vibration and thus may not be suitable for a LiDAR system mounted to a vehicle. Quartz lamps based emission elements can also have a very high operating temperature (e.g., 4000° F.), compared to catalytic-based emission elements, which have an operating temperature of about 800° F. Furthermore, the quartz lamp based emission elements possess the highest color sensitivity, thereby requiring the aperture window to use certain types of materials for better absorbing the radiation having a narrow-band wavelength.

Other materials listed in the table of FIG. 8 may also be used for implementing the emission elements of the emitters (e.g., emitters 730A-730D). For instance, ceramic-based and flat-faced panel based emission elements have low color sensitivities so that the radiation has a wide-band wavelength range. As a result, the aperture window may not need to use specific material to enhance the absorption of the radiation. These two types of emission elements also have medium physical strength, so they are more resistant to physical impact than quartz lamps. The radiant efficiencies of these two types of emission elements are also high, meaning that the power consumption will likely be low. Both ceramic-based and flat faced panel based emission elements may have relatively slow heating up and cooling down speed (e.g., on the order of seconds), compared to quartz lamp based and quartz tube based emission elements. However, the heating up speed may be acceptable for heating up the aperture window of a LiDAR system, because the LiDAR system aperture window is typically small in size (compared to, e.g., a vehicle window). As a result, the amount of heat needed to heat up the small-sized window for evaporating the condensation may be also small and thus the heating up speed for the condensation removing application can be relatively low. It is understood that any types of emission elements can be used to implement the emitters described above (e.g., emitters 730A-730D), depending on the particular dimension of the aperture window, the operational requirements of the LiDAR system, the environment conditions under which the LiDAR system operates, and any other relevant factors. The above examples listed in FIG. 8 mostly use infrared light to provide radiation for removing condensation on an aperture window of a LiDAR system. Another example of an emission element uses white LED or an ultraviolet bulb (UV bulb), thereby utilizing light in the visible and UV light spectrum, as described below in more detail.

With reference back to FIGS. 7A and 7B, as described above, a LiDAR system (e.g., system 300 or 700) operates by scanning light having certain wavelengths, e.g., in the infrared wavelength range. The radiation provided by the emitters (e.g., emitters 730A-730D) for heating up the aperture window 720 also has a wavelength in the infrared wavelength range. The one or more frequencies of the radiation for heating up the aperture window 720 should be different from the frequencies ordinarily detected by LiDAR system 700. The detection light or the transmission light of the LiDAR system 700 are used by the LiDAR system 700 to detect and measure distance and relative angles of objects within a field of view. The transmission light passes through the aperture window 720, by entering the aperture window 720 through the interior aperture surface 722 and then exiting the aperture window 720 through the exterior aperture surface 721. The detection light is received by the LiDAR system 700 in the opposite direction. If the radiation for heating up the aperture window 720 overlaps in wavelength with the LiDAR's transmission light or detection light, interference may occur, causing excessive noise and performance degradation. Therefore, the one or more frequencies of the radiation emitted from the emitters (e.g., 730A-730D) should be sufficiently different from all frequencies of the LiDAR system's operating light (including the transmission light and the detection light). In this disclosure, the terms “frequency” and “wavelength” are both used for describing the electromagnetic radiation emitted by the one or more emitters. It is understood that frequency can be converted to wavelength using the formula f=c/I, where f denotes frequency, c denotes the speed of light, and I denotes the wavelength.

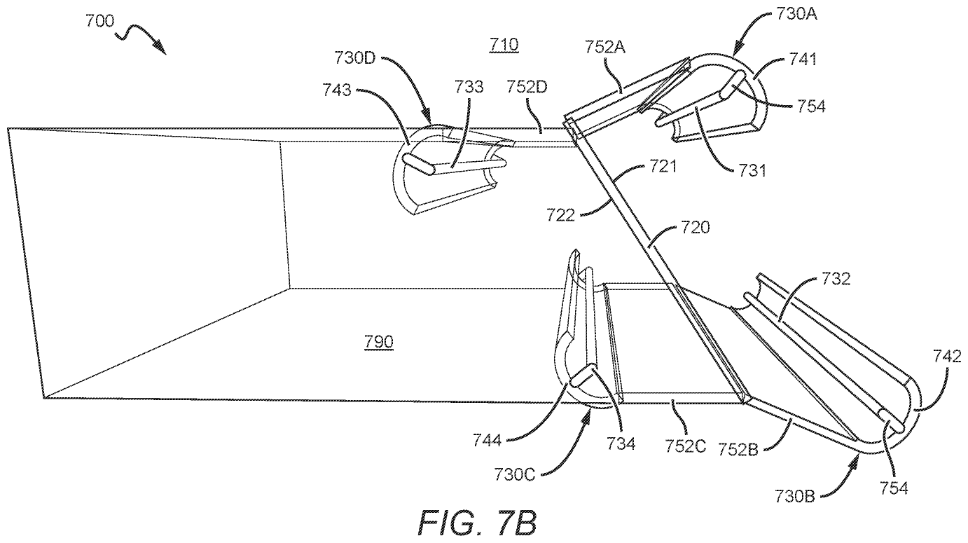

Because the wavelengths of the radiation emitted by the emitters should be sufficiently different from the LiDAR's system's operational wavelength, the selection of the emission elements can impact the performance of the LiDAR system. FIG. 9 illustrates an exemplary emission spectrums of the radiations emitted by several different types of emission elements, including a halogen based emission element, a carbon lamp based emission element, and ceramic based emission element. In FIG. 9, the horizontal axis represents the wavelength in micrometers (μm), and the vertical axis represents the spectral power density in Watt/μm. The spectrums shown in FIG. 9 illustrate that for any type of emission elements, the radiation spectrum has a range of wavelengths with a peak wavelength. For example, halogen based emission elements generate radiation that has a peak wavelength at approximately 1200 nanometers (nm) or 1.2 μm, while carbon based and ceramic based emission elements emit radiation at a peak wavelength at approximately 3 μm. The radiation energy density quickly decreases below 1500 nm or 1.5 μm. FIG. 9 also illustrates several bands of infrared wavelengths, with IR-A band having a wavelength range of approximately 780 nm-1.4 μm, IR-B band having a wavelength range of approximately 1.4 μm- 3 μm; and IR-C band having a wavelength range of approximately 3 μm-1 mm. FIG. 9 further illustrates that different types of emission elements have different spectral power densities at their peak wavelengths. For instance, the halogen based emission elements has a high spectral power density of about 680-690 W/μm with a corresponding temperature of about 2,700° at its peak wavelength; the carbon based emission elements has a medium spectral power density of about 280-290 W/μm with a corresponding temperature of about 650° at its peak wavelength; and the ceramic based emission element has a low spectral power density of about 180-190 W/μm with a corresponding temperature of about 400° C. at its peak wavelength.

The spectral density, the peak wavelength, and the operating temperature at the peak wavelength should also be taking into account when selecting the types of emission elements, again depending on the LiDAR system's operating wavelength, the environmental conditions under which the LiDAR system normally operates, and dimensions/material of the aperture window of the LiDAR system. For example, as shown in FIG. 9, if a LiDAR system's operating wavelength is approximately 1,550 nm or 1.55 μm, the halogen based emission element may not be selected because its peak wavelength is at approximately 1.2 μm. The spectrum of the halogen based emission element may thus overlap with the spectrum of the

LiDAR system's transmission light and/or detection light by a non-insignificant amount. As a result, to avoid interference, the halogen based emission element may not be selected if the LiDAR system's operating wavelength is in the range of 750 nm-2 μm (e.g., 1,550 nm). Instead, carbon lamp based emission element and/or ceramic based emission element may be selected because their peak wavelength is at approximately 3 μm. The radiation from these types of emission elements may have wavelengths greater than or equal to 2 μm, sufficiently separated from the 750 nm-2 μm operating wavelength range of the LiDAR system. As a result, using the carbon lamp based emission element and/or ceramic base emission element, interference of the radiation with the transmission and detection light of a LiDAR system can be reduced or minimized.

For similar reasons, interference can also be reduced or minimized if the emission element is selected such that the radiation has a wavelength range of, for example, below 750 nm. The radiation is thus in the visible or ultraviolet range. While emission elements with radiation in the visible or ultraviolet range can also be used for heating up the condensation, the radiation efficiency may not be as good as those in the infrared wavelength range. As shown in FIG. 9, emissions in the longer wavelength range (e.g., 3 μm or higher) are generally better absorbed by atmosphere, thereby heating up the aperture window faster or more effectively. In contrast, emissions in the shorter wavelength range transmit through the atmosphere better with less absorption, resulting in less absorption by the atmosphere.

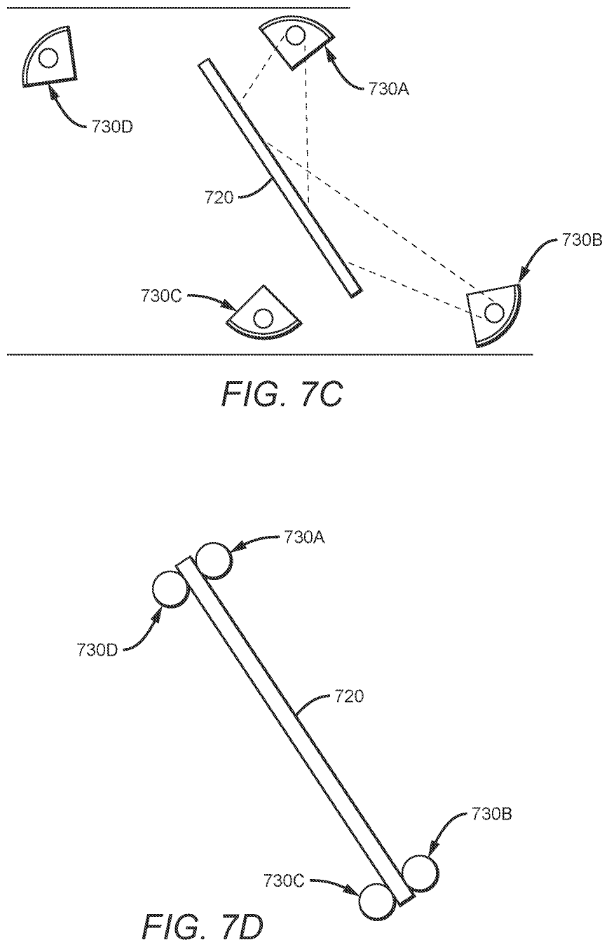

The emission elements 731-734 of one or more electromagnetic radiation emitters 730A-730D (shown in FIGS. 7A-7B) may include at least one of a quartz infrared bulb, a ceramic infrared emitter, a light emitting diode (LED), a tungsten bulb, a carbon lamp bulb, and a UV bulb. One example of the emission element includes a white LED. FIG. 10 illustrates a spectrum of a white LED. In FIG. 10, the horizontal axis represents wavelength in nm, and the vertical axis represents the signal ratio strength (denoted by Sr). As can be seen from FIG. 10, a white LED based emission element may emit radiations at a first peak wavelength of approximately 450 nanometers, a secondary peak wavelength of approximately 550-600 nanometers, and an overall emission band between 400 and 750 nanometers. As such, emissions from a white LED would not generally interfere with the typical wavelengths of detection light of a LiDAR system (e.g., system 300 or 700), which are between 750 nm and 2 μm. FIG. 10 also illustrates that the majority of the emission power of a white LED based emission element falls into the glass absorption band. As a result, if the aperture window (e.g., window 720) is made of a glass material, white LED based emission element may have a good overall efficiency in heating up the glass-based aperture window. Thus, emitters using visible or ultraviolet light (e.g., while LED based emission element) may have an overall better heating effect, cost advantages, and the benefits of minimized interferences (because they do not overlap with the infrared wavelength range at all).

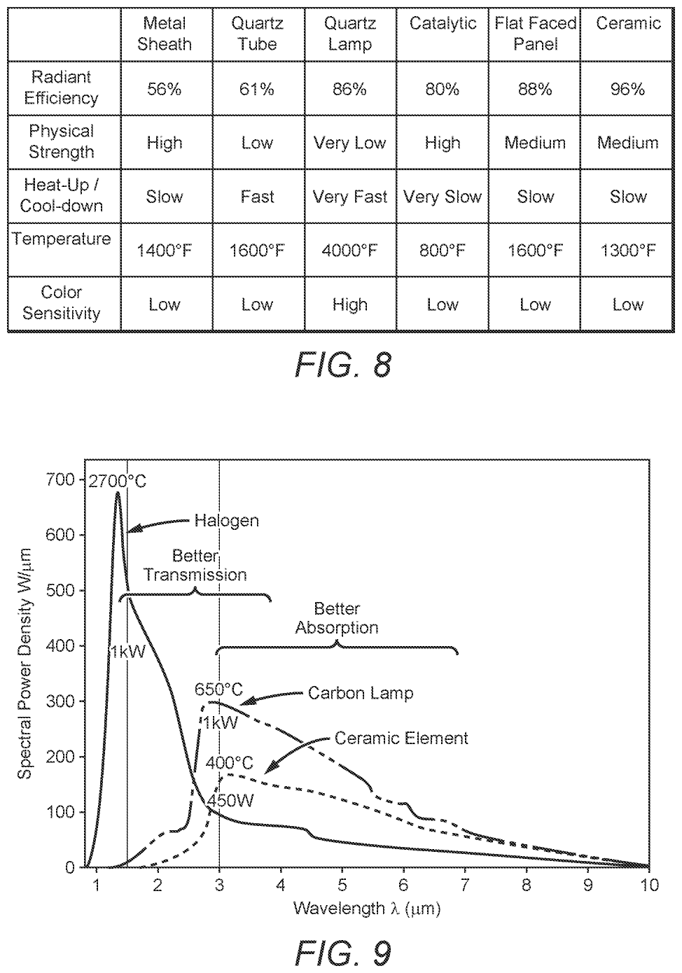

As described above, depending on the type of emission element used in a radiation emitter (e.g., emitter 730), the type of aperture window (e.g., window 720) can be selected to improve the radiation absorption such that the speed of the condensation removal can be improved. One type of the aperture window of a LiDAR system uses glass materials or polycarbonate plastic materials. These types of materials can be highly absorbing of middle-to-far infrared band radiation. Therefore, the aperture window may be naturally heated by radiant heating using the middle-to-far IR band radiation. FIG. 11 illustrates exemplary wavelength transmissivity characteristics of a 10 millimeter thick sample of exemplary uncoated N-BK7 glass typically used for optical applications such as the material for the aperture window of a LiDAR system. As illustrated, the transmissivity of the exemplary sample N-BK7 glass is more than approximately 90% for light having wavelengths between 375 nanometers and 2500 nanometers. The N-BK7 glass absorbs almost all of electromagnetic radiations having wavelengths approximately below 250 nanometers and approximately above 2750 nanometers. This means that such a sample would likely convert electromagnetic radiations having wavelengths approximately below 250 nanometers and approximately above 2750 nanometers into heat, which may be used to heat the glass and evaporate condensation if the glass is used as material for the aperture window. If this type of material is used for the aperture window (e.g., window 720), electromagnetic radiation from the one or more electromagnetic radiation emitters (which have wavelengths greater than or equal to 2 μm, and particularly greater than or equal to 3 μm) can be mostly absorbed and converted to heat to quickly evaporate condensation on the aperture window.

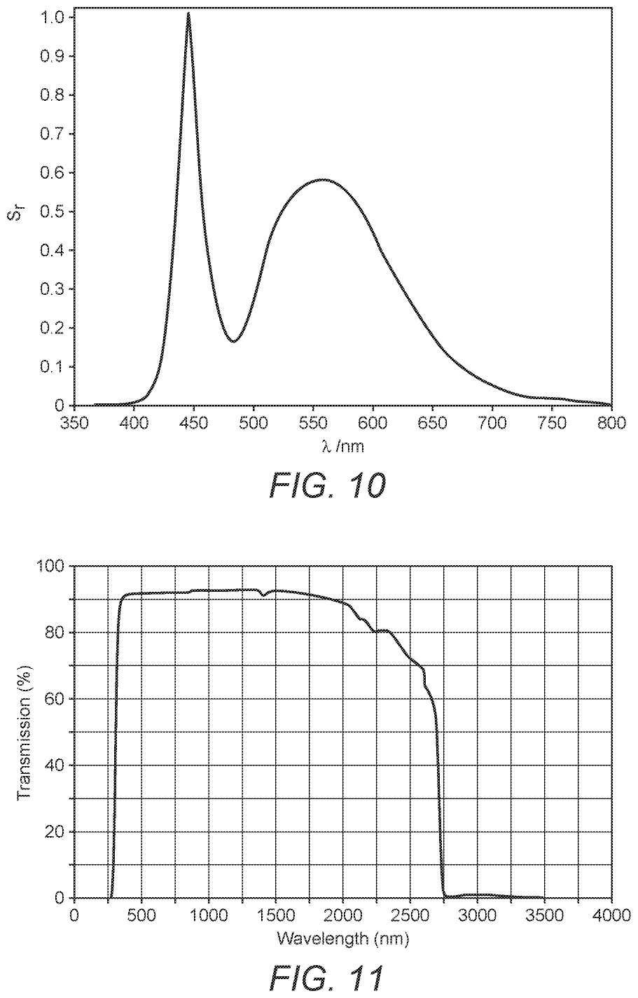

In other embodiments, if the emission elements of a radiation emitter emit visible light or ultraviolet light, as described above, dye material may be added to the aperture window material to better absorb the radiation and convert the radiation to heat. For instance, the aperture window may comprise a tinted glass having a dye material selected to absorb the electromagnetic radiation in the visible and/or ultraviolet wavelength range. FIG. 12 illustrates exemplary wavelength transmissivity characteristics of a 3 millimeter thick sample of exemplary RG-1000 material typically used for optical applications such as material for the aperture window (e.g., window 720). For example, as illustrated, the sample RG-1000 material generally has a transmissivity of above 60% when the wavelength is approximately greater than 1000 nm, and above 90% when the wavelength is approximately greater than 1300 nm. The RG-1000 material, however, absorbs almost all of electromagnetic wavelengths approximately below 800-850 nm. This means that the RG-1000 material can convert electromagnetic radiation having wavelengths approximately below 850 nanometers to heat. If this type of material is used for the aperture window, electromagnetic radiation from the one or more of electromagnetic radiation emitters 731-734 with mostly wavelengths less than or equal to 750 nm can be absorbed and converted to heat to quickly evaporate condensation on the aperture window.

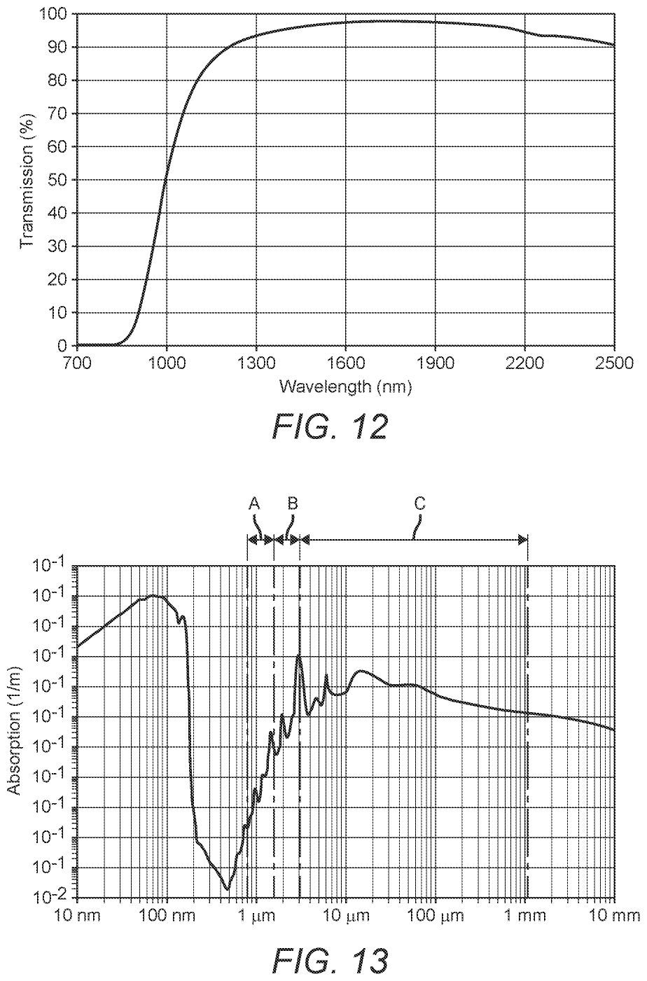

As described above, emission elements of emitters 730 (shown in FIGS. 7A-7B) can emit radiation toward exterior surface 721 and/or interior surface 722 of aperture window 720, thereby heating up the surfaces to evaporate the condensation. By properly selecting the emission wavelength of the radiation (e.g., via using a proper type of material for the emission element), the radiation can also be directly absorbed by the water condensation on the aperture surfaces. FIG. 13 illustrates exemplary wavelength absorption characteristics of water. The horizontal axis represents the wavelength, and the vertical axis represents the absorption capability. For example, as illustrated in FIG. 13, water may naturally have better absorption for electromagnetic radiation having wavelengths approximately below 150 nanometers or approximately above 2 μm. FIG. 13 also illustrates three infrared wavelength bands, i.e., IR-A band having wavelength range of 700 nm -1400 nm, IR-B band having a wavelength range of 1400 nm-3 μm, and IR-C band having a wavelength range of 3 μm-1 mm. In the infrared wavelength range, water has the highest absorption capability at approximately 3 μm.

With reference still to FIG. 13, any electromagnetic radiation from one or more electromagnetic radiation emitters 730 having wavelengths approximately less than or equal to 150 nanometers or approximately greater than or equal to 2 μm can be effective at directly radiating and directly heating water condensation on the aperture window to evaporate the water condensation. IR (infrared) emitters using ceramic based emission elements, with peak wavelengths of approximately 3 μm, may thus be very effective at such direct radiating and direct heating of water condensation. Preferably, the IR emitters should be positioned external to the housing 790 of the LiDAR system 700 to allow direct radiating and direct heating of the condensation formed on the exterior aperture surface 721.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A radiant heating device for removing and preventing condensation on an aperture window of a light ranging and detection (LiDAR) system, the device comprising:
at least one electromagnetic radiation emitter emitting electromagnetic radiation of one or more frequencies,
wherein the at least one electromagnetic radiation emitter is oriented such that the electromagnetic radiation radiates at least one aperture surface of the aperture window of the LiDAR system,
wherein a portion of the electromagnetic radiation of one or more frequencies is absorbed by the aperture window of the LiDAR system and converted to heat, and
wherein the one or more frequencies are different from all frequencies of detection light of the LiDAR system.

2. The device of claim 1, wherein the at least one electromagnetic radiation emitter is positioned external to the LiDAR system.

3. The device of claim 1, wherein the at least one electromagnetic radiation emitter is positioned internal to the LiDAR system.

4. The device of claim 1, wherein the at least one electromagnetic radiation emitter is configured such that the electromagnetic radiation radiates toward an aperture surface that is exterior of the LiDAR system.

5. The device of claim 1, wherein the at least one electromagnetic radiation emitter is configured such that the electromagnetic radiation radiates toward an aperture surface that is interior of the LiDAR system.

6. The device of claim 1, wherein each of the at least one electromagnetic radiation emitter includes one or more reflectors configured to reflect at least a portion of the electromagnetic radiation toward the at least one aperture surface of the aperture window.

7. The device of claim 6, wherein at least one of the one or more reflectors is directly contacting the aperture window to transfer heat by conduction to the aperture window.

8. The device of claim 1, wherein the electromagnetic radiation from the at least one electromagnetic radiation emitter includes wavelengths greater than or equal to 2 μm.

9. The device of claim 1, wherein the electromagnetic radiation from the at least one electromagnetic radiation emitter includes wavelengths less than or equal to 750 nanometers.

10. The device of claim 1, wherein the at least one electromagnetic radiation emitter comprises at least one of a quartz infrared bulb, a ceramic infrared emitter, a light emitting diode, and a UV bulb.

11. A Light Ranging and Detection (LiDAR) system configured to transmit transmission light to illuminate one or more objects in a field-of-view (FOV) and receive detection light, the LiDAR system comprising:
a housing enclosing at least a portion of the LiDAR system, the housing having an aperture window for passing the transmission light and the detection light;
one or more supporting arms coupled to the housing of the LiDAR system, the supporting arms being positioned proximate to the aperture window;
at least one electromagnetic radiation emitter coupled to the one or more supporting arms or a portion of the housing; and
a controller configured to control the at least one electromagnetic radiation emitter to emit electromagnetic radiation of one or more frequencies,
wherein the at least one electromagnetic radiation emitter is oriented such that the electromagnetic radiation radiates toward at least one aperture surface of the aperture window of the LiDAR system,
wherein a portion of the electromagnetic radiation of one or more frequencies is absorbed by the aperture window of the LiDAR system and converted to heat, and
wherein the one or more frequencies are different from all frequencies of detection light of the LiDAR system.

12. The system of claim 11, wherein the at least one electromagnetic radiation emitter is disposed outside of light paths of the detection light.

13. The system of claim 11, wherein the at least one electromagnetic radiation emitter comprises:
one or more emission elements controllable to emit the electromatic radiation; and
one or more reflectors configured to reflect the emitted electromagnetic radiation.

14. The system of claim 13, wherein at least one emission element of the one or more emission elements has a bar shape, the at least one emission element being positioned substantially parallel to the at least one aperture surface along its longitudinal direction of the at least one emission element.

15. The system of claim 13, wherein at least one reflector of the one or more reflectors has a curved shape, the curvature of the at least one reflector is configured to focus the electromatic radiation onto the at least one aperture surface.

16. The system of claim 11, wherein the at least one electromagnetic radiation emitter is positioned external to the LiDAR system.

17. The system of claim 11, wherein the at least one electromagnetic radiation emitter is positioned internal of the LiDAR system.

18. The system of claim 11, wherein the at least one electromagnetic radiation emitter directly contacts the aperture window to transfer heat by conduction to the aperture window.

19. The system of claim 11, further comprising:
a condensation monitor comprising one or more sensors mounted to the aperture window or the housing, the condensation monitor being configured to monitor condensation on the at least one aperture surface and communicate a condensation monitoring result to the controller;
wherein the controller is further configured to control the at least one electromatic radiation emitter based on the condensation monitoring result.

20. The system of claim 12, wherein the aperture window comprises a tinted glass having a dye material selected to absorb the electromagnetic radiation.

21. A vehicle comprising a radiant heating device for removing and preventing condensation on an aperture window of a light ranging and detection (LiDAR) system, the device comprising:
at least one electromagnetic radiation emitter emitting electromagnetic radiation of one or more frequencies,
wherein the at least one electromagnetic radiation emitter is oriented such that the electromagnetic radiation radiates at least one aperture surface of the aperture window of the LiDAR system,
wherein a portion of the electromagnetic radiation of one or more frequencies is absorbed by the aperture window of the LiDAR system and converted to heat, and
wherein the one or more frequencies are different from all frequencies of detection light of the LiDAR system.
